(19) United States
(12) Patent Application Publication
(10) Pub. No.: US 2026/0220678 A1
(43) Pub. Date: Jul. 30, 2026

(54) AI AGENT-DRIVEN AUTONOMOUS ONLINE SHOPPING SUPPORT SYSTEM WITH MULTIMODAL CONTEXT ANALYSIS AND HETEROGENEOUS DIGITAL TERRITORY INJECTION

(71) Applicants: Tae Sung CHUNG, Seoul (KR); Baekhyo CHUNG, Seoul (KR); Sihyo CHUNG, Seoul (KR); Chanhyo CHUNG, Seoul (KR)

(72) Inventors: Tae Sung CHUNG, Seoul (KR); Baekhyo CHUNG, Seoul (KR); Sihyo CHUNG, Seoul (KR); Chanhyo CHUNG, Seoul (KR)

(21) Appl. No.: 19/577,501

(22) Filed: Mar. 25, 2026

Related U.S. Application Data
(63) Continuation-in-part of application No. 18/907,459, filed on Oct. 4, 2024.

(51) Int. Cl. G06Q 30/0601

(52) U.S. Cl. CPC G06Q 30/0619; G06Q 30/0605

(57) ABSTRACT

An AI agent-driven online shopping support system and method autonomously deploys online price tags as transaction nodes across heterogeneous digital territories including web pages, social media platforms, live streaming environments, metaverse spaces, and augmented reality wearable device environments. A digital territory scanner discovers content-bearing territories. A context analysis engine analyzes content across one or more modalities—text, image, video, and audio—to generate a semantic context representation. An authorization module obtains insertion authorization from target digital territories. An optimization engine selects optimal product-seller-price configurations by computing optimization scores based on one or more commerce performance components. A runtime node injection engine injects online price tags through DOM injection, video overlay injection, or AR spatial injection, with logical binding to content context through binding annotations. An exhibition fee comprising at least one of an impression-based component and a performance-based component, less AI operational costs, is attributed to an exhibitor identifier associated with each injected online price tag. A closed-loop feedback module continuously updates model parameters from transaction outcomes.

### CROSS-REFERENCE TO RELATED APPLICATIONS

This application is a Continuation-in-Part of U.S. patent application Ser. No. 18/907,459, which is a continuation of U.S. Pat. No. 12,141,846 B2 (U.S. application Ser. No. 17/713,383, filed Apr. 5, 2022), the entire contents of which are incorporated herein by reference. U.S. Pat. No. 12,141,846 B2 claims priority to PCT Application No. PCT/KR2020/013134, filed Sep. 25, 2020, which claims priority to Korean Patent Application No. 10-2019-0123754, filed Oct. 7, 2019, the entire contents of all of which are incorporated herein by reference.

### TECHNICAL FIELD

The present invention relates to an online shopping support system and method, and more particularly, to an AI agent-driven system and method for autonomously deploying and managing online price tags across heterogeneous digital territories through multimodal semantic context analysis, agent-to-agent authorization protocols, sandboxed runtime node injection, triple-win optimization among exhibitors, sellers, and buyers, and closed-loop reinforcement learning for continuous self-improvement of transaction matching accuracy.

### BACKGROUND OF THE INVENTION

The parent patent, U.S. Pat. No. 12,141,846 B2 (“the '846 patent”), discloses an online shopping support device and method wherein a generation unit generates an embedding code for an online price tag, an identification unit identifies the online price tag embedded in an exhibitor's webpage, an update unit updates a selling price of a product through a reverse auction among sellers, a processing unit processes a purchase when a purchaser's purchase intent is identified, and an issue unit issues an exhibition fee to the exhibitor as a reward. The '846 patent established the foundational architecture of embedding transaction nodes-referred to as “online price tags”-within digital content created by exhibitors (e.g., bloggers, YouTubers, social media users), enabling these exhibitors to earn exhibition fees when transactions are completed through their embedded price tags.

While the '846 patent represents a significant advance in enabling individual content creators to participate as commerce intermediaries, several technical challenges have emerged that are not addressed by the prior art:

First, the prior art requires exhibitors to manually identify products and manually insert embedding codes, an approach that is technically infeasible as digital territories have expanded to include live streaming, social media, metaverse, and augmented reality environments.

Second, prior art product-to-content matching relies on keyword or category-based association, which fails to exploit the multimodal semantic context available in text, image, video, and audio content.

Third, existing commerce optimization systems maximize a single objective (e.g., lowest price or highest margin), without simultaneously balancing the interests of the exhibitor, the seller, and the buyer in the exhibition-based commerce model.

Fourth, the static embedding code approach of the '846 patent does not extend to non-web environments requiring runtime injection with temporal binding to video timestamps or spatial binding to physical objects in AR.

Fifth, the prior art revenue model is limited to commission-on-sale, without a hybrid structure combining impression-based and performance-based compensation with AI operational cost accounting.

Sixth, prior art systems lack closed-loop feedback mechanisms for continuously improving context-product matching accuracy through reinforcement learning based on transaction outcomes.

Therefore, there is a need in the art for an AI agent-driven online shopping support system that extends the online price tag architecture of the '846 patent to autonomously deploy transaction nodes across heterogeneous digital territories through multimodal semantic analysis, agent-to-agent authorization protocols, runtime node injection, multi-objective optimization, hybrid revenue accounting, and closed-loop reinforcement learning.

The present invention is directed to commerce deployment systems operating exclusively within remotely accessible online environments, wherein content territories are dynamically rendered and remotely accessible without requiring physical proximity between a buyer and a commerce display device. This technical domain is structurally distinct from physical-space commerce systems that rely on co-located electronic display hardware, proximity-based wireless communication, or sensor-driven demand detection at a fixed physical installation.

### SUMMARY OF THE INVENTION

The present invention provides an AI agent-driven online shopping support system and method that extends the online price tag architecture established by the '846 patent with novel AI agent capabilities for autonomous deployment and optimization of online price tags across heterogeneous digital territories.

In a first aspect, the present invention provides an AI agent-driven online shopping support system comprising: a digital territory scanner configured to autonomously scan a plurality of heterogeneous digital territories including at least web-based territories, social media platform territories, live streaming territories, and augmented reality interface territories; a multimodal context analysis engine configured to extract semantic feature vectors from multimodal content within the scanned digital territories, the multimodal content comprising at least one of text, image, video, and audio data; an agent-to-agent authorization module configured to execute an encrypted handshaking protocol with platform APIs of the heterogeneous digital territories to obtain insertion rights for deploying online price tags; a runtime node injection engine configured to inject online price tags as sandboxed transaction nodes into the heterogeneous digital territories, wherein the injected online price tags are logically bound to the semantic context of the surrounding content; a triple-win optimization engine configured to compute an optimization score as a weighted sum of exhibitor revenue, seller transaction volume, and buyer utility, and to select a product-price combination that maximizes the optimization score; an AI operational cost accounting module configured to compute and deduct AI processing costs from gross exhibition fees based on the type and volume of multimodal analysis performed; and a closed-loop feedback module configured to receive transaction outcome data and buyer satisfaction signals and to update model parameters of the multimodal context analysis engine and the triple-win optimization engine through reinforcement learning.

In a second aspect, the present invention provides a method for AI agent-driven autonomous deployment of online price tags across heterogeneous digital territories, the method comprising: autonomously scanning, by an AI agent executing on a processor, a plurality of heterogeneous digital territories; performing multimodal semantic context analysis on content within the scanned territories to generate semantic feature vectors; executing an agent-to-agent handshaking protocol to obtain authorization tokens for online price tag insertion; selecting, using a triple-win optimization function, a product and price combination that optimizes a weighted combination of exhibitor revenue, seller transaction volume, and buyer utility; injecting the online price tag as a sandboxed transaction node into the digital territory according to an injection method determined by the territory type; computing a hybrid exhibition fee comprising an impression-based component and a performance-based commission component, less AI operational costs; and updating reinforcement learning model parameters based on transaction outcome data.

Additional aspects, features, and advantages of the present invention will become apparent from the detailed description of the preferred embodiments set forth below.

### BRIEF DESCRIPTION OF THE DRAWINGS

The accompanying drawings, which are incorporated in and constitute a part of this specification, illustrate preferred embodiments of the invention and together with the description serve to explain the principles of the invention.

FIG. 1 is a schematic diagram illustrating the overall system architecture of the AI Commerce Platform according to an embodiment of the present invention, showing the interconnection of the AI agent orchestration layer, the digital territory interface layer, the context analysis engine (e.g., multimodal analysis pipeline), the optimization engine (e.g., triple-win optimization engine), the runtime node injection engine, the hybrid revenue accounting module, and the closed-loop feedback module, all operating in conjunction with the online price tag transaction node framework established by the parent patent.

FIG. 2 is a block diagram illustrating the system components of the AI agent-driven online shopping support device according to an embodiment of the present invention, extending the component architecture of the parent patent (which disclosed generation unit 10, identification unit 20, update unit 30, processing unit 40, issue unit 50, and communication unit 60) with new components including: an AI agent orchestration unit 70, a context analysis unit 80 (implemented as a multimodal context analysis unit), a digital territory scanner unit 90, an optimization unit 100 (implemented as a triple-win optimization unit), a runtime node injection unit 110, an AI cost accounting unit 120, and a closed-loop feedback unit 130, wherein all new components operate through and in conjunction with the online price tag transaction node framework.

FIG. 3 is a flowchart illustrating the authorization module protocol (e.g., agent-to-agent authorization handshaking) (300) according to an embodiment of the present invention, showing: the initiation of an authorization request by the AI agent to a target platform API; the transmission of an exhibitor policy certificate containing delegation constraints; the platform API's validation of the certificate against platform-specific permission rules; the issuance of an insertion authorization (e.g., a time-limited encrypted insertion token); the storage of the insertion authorization in a secure token vault; and the expiration and renewal cycle of insertion authorizations.

FIG. 4 is a block diagram illustrating the context analysis engine (e.g., multimodal context analysis pipeline) according to an embodiment of the present invention, showing parallel processing streams for: (a) a text analysis stream comprising a natural language processing module for analyzing blog post text, captions, hashtags, and transcript data to extract semantic concept vectors; (b) an image analysis stream comprising a computer vision module for detecting objects, logos, and product visual features in static images and video keyframes to extract visual feature vectors; (c) a video analysis stream comprising a temporal object detection module for performing real-time object detection across video frames and generating timestamp-indexed binding annotations; (d) an audio analysis stream comprising a speech-to-text recognition module for transcribing live audio streams and detecting product mentions with temporal position data; and (e) a multimodal fusion module that combines the outputs of all streams into a unified semantic context vector used for product matching.

FIG. 5 is a flowchart illustrating the optimization engine (e.g., triple-win optimization) and product-price matching process according to an embodiment of the present invention, showing: the input of the unified semantic context vector; the retrieval of candidate product listings from participating sellers; the computation of the optimization score Score=W1 (Exhibitor Revenue)+W2 (Seller Volume)+W3 (Buyer Utility) for each candidate; the dynamic adjustment of weight coefficients W1, W2, W3 by the AI weight controller based on current system state parameters including platform saturation index, exhibitor performance score, and market demand index; the equilibrium matching process that identifies the Pareto-optimal product-price combination; and the output of the selected online price tag configuration.

FIG. 6 is a combined flowchart and architecture diagram illustrating the runtime node injection process according to an embodiment of the present invention, showing two primary injection pathways: (a) a DOM injection pathway for web-based territories including static HTML pages, single-page applications (SPA/React), and content management systems such as WordPress, wherein the injection engine traverses the Document Object Model, identifies semantic anchor points corresponding to the context vector, and inserts an online price tag widget (e.g., a sandboxed widget); and (b) a video overlay injection pathway for streaming territories including TikTok, YouTube Live, and other video platforms, wherein the injection engine inserts a transparent overlay layer rendered above the video frame, with the online price tag appearing at timestamps and spatial coordinates determined by the temporal object detection output of the video analysis stream; and (c) an AR spatial injection pathway for augmented reality interface territories, wherein the injection engine registers the online price tag as a spatial anchor bound to a physical object detected by the AR sensor array.

FIG. 7 is a block diagram illustrating the revenue distribution and settlement architecture according to an embodiment of the present invention, showing: the computation of gross impression revenue as a function of valid verified exposures multiplied by a CPM rate; the computation of gross performance commission as a percentage of completed transaction value; the deduction of AI operational costs computed by the AI cost accounting module based on the type and volume of multimodal analysis performed (text analysis cost tier, image analysis cost tier, video/audio analysis cost tier); the computation of net exhibition fee payable to the exhibitor; the seller transaction settlement process; and the system platform fee computation.

FIG. 8 is a flowchart illustrating the closed-loop feedback and reinforcement learning process according to an embodiment of the present invention, showing: the collection of transaction outcome signals including purchase completion events, buyer satisfaction ratings, product return events, and click-through rate measurements; the computation of a reward signal based on the weighted outcome data; the update of Q-value parameters in the reinforcement learning model of the optimization engine (e.g., triple-win optimization engine); the update of context-product matching weights in the context analysis engine (e.g., multimodal context analysis engine); the update of exhibitor territory performance scores; and the periodic retraining cycle for batch model updates.

FIG. 9A is a user interface diagram illustrating an example of an online price tag as displayed within a web-based digital territory (910) according to an embodiment of the present invention, showing: a blog post environment with embedded text and images; an online price tag widget (e.g., sandboxed) rendered at a semantic anchor point within the content; the price tag widget displaying a product image, product name, current reverse-auction lowest price, seller identifier, and a purchase action element; an impression telemetry indicator; and an exhibitor attribution identifier.

FIG. 9B is a user interface diagram illustrating an example of an online price tag as displayed within a live streaming digital territory (920) according to an embodiment of the present invention, showing: a live video stream with a presenter discussing a product; a transparent overlay layer rendered above the video stream; an online price tag widget appearing in the overlay layer at a timestamp and position corresponding to the moment and location the AI audio analysis stream detected a product mention; the price tag widget displaying product details and a touch-activated purchase element; and a telemetry engagement indicator.

FIG. 10 is a perspective diagram illustrating an example of an online price tag as displayed within an augmented reality wearable device digital territory according to an embodiment of the present invention, showing: a first-person view through an AR wearable device (such as smart glasses or a pendant display); a physical object in the field of view that has been identified by the AR sensor array and matched to a product in the product database; a spatially anchored online price tag appearing as an AR overlay directly associated with the identified physical object; the AR overlay displaying product information, current price from the reverse auction, and an interaction gesture zone for purchase initiation; and an exhibitor attribution tag indicating the exhibitor whose policy parameters governed the deployment of this online price tag.

### DETAILED DESCRIPTION OF THE PREFERRED EMBODIMENTS

The present invention will now be described in detail with reference to the accompanying drawings. The following description is provided to enable a person skilled in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

### TERMINOLOGY AND DEFINITIONS

As used herein and in the claims, the following terms shall have the meanings set forth below:

“Context analysis engine” refers to any engine or module configured to analyze content within digital territories to generate a semantic context representation. In a preferred embodiment, the context analysis engine is implemented as a multimodal context analysis engine that analyzes content across multiple modalities including text, image, video, and audio data. However, the context analysis engine encompasses single-modality implementations (e.g., text-only analysis) as well as any subset of modalities.

“Semantic context representation” refers to any data structure representing the semantic subject matter of analyzed content, including but not limited to a unified semantic context vector, a semantic embedding, a feature tensor, or any other computational representation that captures the meaning and context of the analyzed content.

“Authorization module” refers to any module configured to obtain permission to inject an online price tag into a target digital territory. In a preferred embodiment, the authorization module is implemented as an agent-to-agent authorization module that executes a cryptographic handshaking protocol with a platform API to obtain an encrypted insertion token. However, the authorization module encompasses any mechanism for obtaining insertion permission, including API key-based authorization, OAuth token exchange, pre-configured access credentials, or any other programmatic authorization mechanism.

“Insertion authorization” refers to any credential, token, permission, or data structure that authorizes injection of an online price tag into a digital territory, including but not limited to an encrypted insertion token, an API key, an OAuth access token, a session credential, a pre-configured permission grant, or a user-delegated permission obtained through a client-side agent such as a browser extension, mobile application, or operating system-level content layer that acts on behalf of the user to permit content injection into the user's rendered view of the digital territory.

“Optimization engine” refers to any engine or module configured to select an optimized product-seller-price tuple based on one or more commerce performance components. In a preferred embodiment, the optimization engine is implemented as a triple-win optimization engine that computes an optimization score as a weighted sum of an exhibitor revenue component, a seller transaction volume component, and a buyer utility component. However, the optimization engine encompasses single-objective optimization (e.g., maximizing seller revenue alone), dual-objective optimization, or any other scoring function that selects products for display. As used herein, “select” by the optimization engine includes both fully autonomous selection (where no human intervention occurs) and human-supervised selection (where the optimization engine computes and recommends an optimized tuple that is subsequently confirmed, approved, or accepted by a human operator before deployment); in the latter case, the optimization engine is still considered to “select” the optimized tuple because the substantive selection decision-including candidate generation, scoring, and ranking—is performed by the engine.

“Commerce performance components” refers to any measurable factors relevant to commerce outcomes used by the optimization engine, including but not limited to exhibitor revenue, seller transaction volume, buyer utility, conversion rate, click-through rate, relevance score, or any combination thereof.

“Transaction node” refers to an online price tag injected into a digital territory that serves as a point of commerce interaction. In a preferred embodiment, the transaction node is implemented as a sandboxed transaction node executing in an isolated execution context (e.g., an iframe sandbox or shadow DOM). However, the transaction node encompasses any implementation of the online price tag within a digital territory, whether sandboxed or directly integrated.

“Digital territory” refers to any digital environment having a dynamic rendering area capable of displaying content, including but not limited to web-based territories (websites, web applications), content management system territories (WordPress, Shopify), social media platform territories, live streaming territories, messaging and chat interface territories, metaverse and virtual space territories, and augmented reality wearable device territories.

### I. Over View and Relationship to Parent Patent

The present invention is a Continuation-in-Part of U.S. Pat. No. 12,141,846 B2 (“the '846 patent”). The '846 patent discloses an online shopping support device comprising a generation unit 10 that generates an embedding code for an online price tag, an identification unit 20 that identifies the online price tag embedded in an exhibitor's webpage, an update unit 30 that updates a selling price through a reverse auction among sellers, a processing unit 40 that processes a purchase upon identification of a purchaser's purchase intent, and an issue unit 50 that issues an exhibition fee to the exhibitor as a reward for the transaction.

The present invention fully incorporates and extends the architecture of the '846 patent. All new matter disclosed herein operates through and in conjunction with the online price tag transaction node framework of the '846 patent. The online price tag remains the central transaction node of the present invention. All AI-driven autonomous capabilities, multimodal analysis outputs, optimization computations, and revenue settlements described herein are ultimately instantiated, tracked, and settled through the online price tag as defined in the '846 patent. The exhibitor identification mechanism of the '846 patent-which attributes transactions to the exhibitor whose embedding code generated the online price tag-serves as the foundational attribution and settlement mechanism for all new capabilities disclosed herein.

The new matter of the present invention provides six categories of novel technical contribution: (1) AI agent-based autonomous exhibition through a digital territory scanner and agent-to-agent authorization protocol; (2) multimodal semantic context analysis through parallel NLP, computer vision, video temporal detection, and audio speech recognition pipelines; (3) triple-win optimization through a multi-objective weighted scoring function with dynamic weight adjustment; (4) sandboxed runtime node injection across DOM-based, video overlay, and AR spatial injection pathways; (5) a hybrid revenue structure combining impression-based and performance-based compensation with AI operational cost deduction; and (6) closed-loop reinforcement learning feedback for continuous system self-improvement.

### II. System Architecture

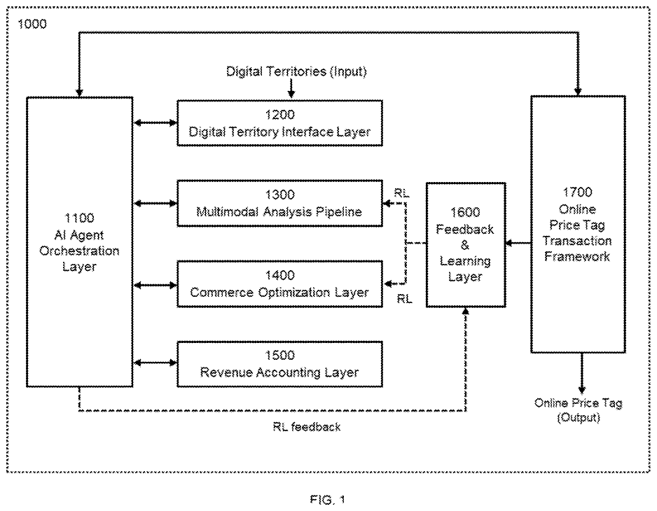

Referring to FIG. 1, the AI Commerce Platform 1000 according to an embodiment of the present invention comprises the following primary layers and modules:

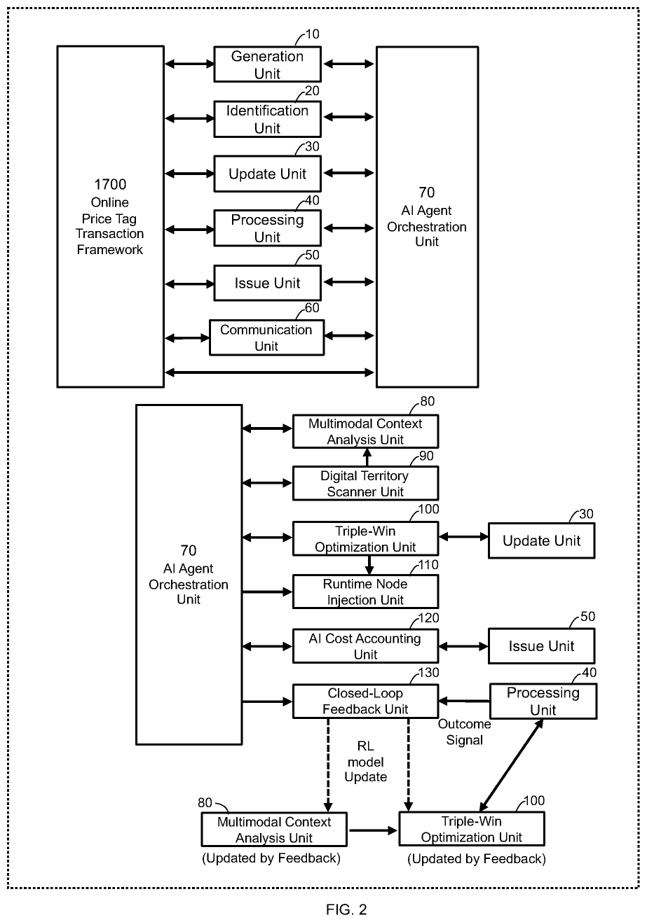

An AI Agent Orchestration Layer 1100 coordinates the autonomous operation of all AI-driven subsystems. The AI Agent Orchestration Layer 1100 includes an AI agent orchestration unit 70 (shown in FIG. 2) that manages the lifecycle of AI agent tasks, schedules multimodal analysis jobs, monitors agent health status, and coordinates the handshaking protocol with external platform APIs.

A Digital Territory Interface Layer 1200 provides abstractions for interacting with heterogeneous digital territories. The Digital Territory Interface Layer 1200 includes the digital territory scanner unit 90 and the runtime node injection unit 110 (shown in FIG. 2). The Digital Territory Interface Layer 1200 maintains a territory registry that maps territory types to their corresponding injection methods and handshaking protocols.

A Multimodal Analysis Pipeline 1300 performs semantic content analysis across text, image, video, and audio modalities. The Multimodal Analysis Pipeline 1300 is implemented by the multimodal context analysis unit 80 (shown in FIG. 2).

A Commerce Optimization Layer 1400 performs product selection and price optimization. The Commerce Optimization Layer 1400 is implemented by the triple-win optimization unit 100 (shown in FIG. 2) and builds upon the update unit 30 and processing unit 40 of the '846 patent.

A Revenue Accounting Layer 1500 computes and settles exhibition fees under the hybrid revenue model. The Revenue Accounting Layer 1500 is implemented by the AI cost accounting unit 120 (shown in FIG. 2) and extends the issue unit 50 of the '846 patent.

A Feedback and Learning Layer 1600 collects transaction outcome data and updates model parameters. The Feedback and Learning Layer 1600 is implemented by the closed-loop feedback unit 130 (shown in FIG. 2).

All layers communicate through the Online Price Tag Transaction Framework 1700, which implements the online price tag as defined in the '846 patent and serves as the central data structure for all attribution, transaction processing, and settlement operations.

### III. System Components

Referring to FIG. 2, the AI agent-driven online shopping support device according to an embodiment of the present invention comprises the components of the '846 patent (generation unit 10, identification unit 20, update unit 30, processing unit 40, issue unit 50, and communication unit 60) and additionally comprises the following new components:

### A. AI Agent Orchestration Unit 70

The AI agent orchestration unit 70 is a software-implemented agent execution environment running on one or more processors. The AI agent orchestration unit 70 implements a task planning engine that decomposes high-level exhibitor policy objectives into concrete executable subtasks. The AI agent orchestration unit 70 maintains a task queue and assigns tasks to specialized sub-agents for execution. Sub-agents include a territory scanning agent, a multimodal analysis agent, an authorization agent, a product matching agent, and a node injection agent.

The AI agent orchestration unit 70 accepts exhibitor policy parameters as input. An exhibitor policy is a structured data object comprising: (a) a minimum commission rate threshold below which the AI agent shall not deploy online price tags; (b) a content category filter list specifying the types of product categories the exhibitor permits to be associated with their content; (c) territory type permissions specifying which digital territory types the exhibitor authorizes for autonomous deployment; (d) a maximum AI operational cost budget per deployment period; and (e) optional keyword blacklists and whitelists for context filtering. The exhibitor policy is digitally signed by the exhibitor and stored as an exhibitor policy certificate in a persistent data store accessible to the AI agent orchestration unit 70.

The AI agent orchestration unit 70 operates in a continuous execution loop. In each iteration of the loop, the orchestration unit 70 retrieves the exhibitor's policy certificate, invokes the digital territory scanner unit 90 to identify new or updated content within authorized territories, dispatches multimodal analysis tasks to the multimodal context analysis unit 80, receives analysis results, dispatches optimization tasks to the triple-win optimization unit 100, receives optimized product-price configurations, dispatches injection tasks to the runtime node injection unit 110, and logs all events for subsequent processing by the closed-loop feedback unit 130.

### B. Context Analysis Unit (Multimodal Context Analysis Unit) 80

The multimodal context analysis unit 80 performs semantic analysis of content within digital territories to generate a unified semantic context vector used for product matching. The multimodal context analysis unit 80 comprises four parallel analysis modules:

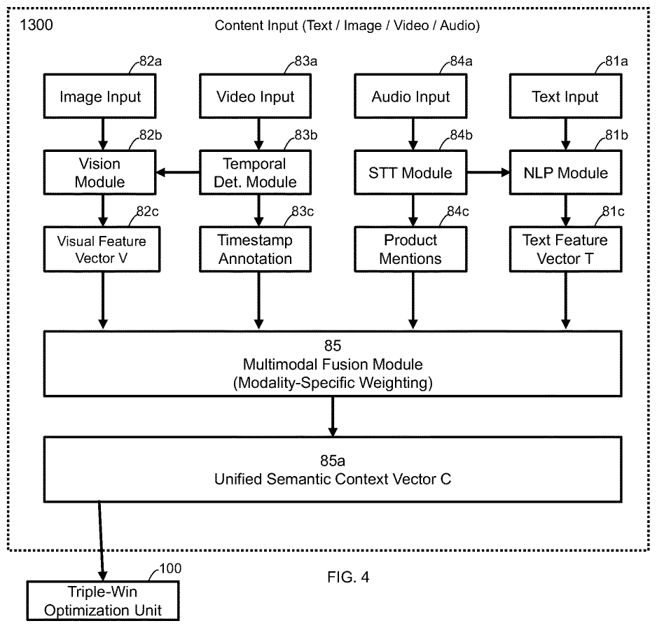

Text Analysis Module 81: The text analysis module 81 implements a natural language processing (NLP) pipeline for analyzing textual content. Referring to FIG. 4, text input data (81a in FIG. 4) for the text analysis module includes blog post body text, article titles, captions, hashtag strings, product review text, and transcript data. The NLP module (81b in FIG. 4) applies tokenization, part-of-speech tagging, named entity recognition (NER) for identifying product names, brand names, and product attributes, and semantic embedding using a pre-trained language model (e.g., a transformer-based architecture). The output of the text analysis module 81 is a text semantic feature vector T∈ [symbol] \hat{ }d_t (81c in FIG. 4), where d_t is the dimensionality of the text embedding space.

Image Analysis Module 82: The image analysis module 82 implements a computer vision pipeline for analyzing visual content in static images and video keyframes. Image input data (82a in FIG. 4) for the image analysis module 82 includes JPEG, PNG, WebP, and other static image formats, as well as keyframe images extracted from video content at regular intervals. The vision module (82b in FIG. 4) applies: (a) object detection using a convolutional neural network (CNN) trained to identify product categories, physical objects, and scenes relevant to commercial products; (b) logo recognition to identify brand identities present in the image; (c) visual similarity search against a product visual database to identify specific products depicted; and (d) visual embedding generation using a visual encoder network. The output of the image analysis module 82 is a visual semantic feature vector V∈ [symbol] \hat{ }d_v (82c in FIG. 4), where d_v is the dimensionality of the visual embedding space, together with a set of detected object annotations {(object_id, confidence, bounding_box)} for each detected object.

Video Analysis Module 83: The video analysis module 83 implements a temporal object detection pipeline for video content. Video input data (83a in FIG. 4) is processed by the temporal detection module (83b in FIG. 4) in real time or near-real time by extracting frame sequences at a configured frame rate and passing each frame to the image analysis module 82 for object detection. Additionally, the video analysis module 83 applies temporal consistency tracking to associate object detections across consecutive frames, thereby generating temporal object tracks with associated start and end timestamps. For each detected product-related object track, the video analysis module 83 generates a timestamp-indexed binding annotation B=(product_id, t_start, t_end, confidence, spatial_region) (83c in FIG. 4), where t_start and t_end define the temporal interval of the object's visibility, and spatial_region defines the bounding region within the frame where the detected object appears. These binding annotations are used by the runtime node injection unit 110 to position and time-synchronize video overlay injections of online price tags.

Audio Analysis Module 84: The audio analysis module 84 implements a speech-to-text (STT) recognition pipeline for audio content in live streams and recorded video. Audio input data (84a in FIG. 4) is received by the STT module (84b in FIG. 4), which applies voice activity detection to identify speech segments, passes speech segments to an STT recognition engine to produce text transcripts, and applies the text analysis module 81 to the resulting transcripts. Additionally, the audio analysis module 84 maintains a real-time product mention detection model that identifies specific product names, brand names, and product attribute phrases within the transcript stream and emits product mention events (84c in FIG. 4) with associated timestamps. A product mention event is a structured data object comprising: (a) the detected product or brand name; (b) the timestamp of the mention within the audio stream; (c) a confidence score; and (d) a contextual phrase window of N tokens surrounding the mention. Product mention events are used by the runtime node injection unit 110 to trigger time-synchronized injection of online price tags in video overlay layers.

Multimodal Fusion Module 85: The multimodal fusion module 85 (shown in FIG. 4) receives the outputs of the text analysis module 81, the image analysis module 82, the video analysis module 83, and the audio analysis module 84 and computes a unified semantic context vector C∈ [symbol] \hat{ }d_c (85a in FIG. 4). The unified semantic context vector C is computed by a fusion network that applies modality-specific weighting to each input feature vector and combines them through a learned aggregation function. The modality weights are dynamically adjusted based on the availability and quality of each modality's input data. If no image data is present, the image modality weight is set to zero and the remaining modality weights are renormalized. The unified semantic context vector C is passed to the triple-win optimization unit 100 as the primary input for product matching.

### C. Digital Territory Scanner Unit 90

The digital territory scanner unit 90 is responsible for discovering and monitoring digital territories that are authorized for online price tag deployment under the exhibitor's policy. A digital territory is defined in the present invention as any digital environment that satisfies the following criteria: (a) it has a unique resource identifier (URI) or an equivalent addressing scheme that uniquely identifies the territory; (b) it has one or more data input fields through which content or user interactions are received; and (c) it has a dynamic rendering area in which visual, auditory, or spatial content is presented to end users.

Digital territories within the scope of the present invention include but are not limited to:
1. Static/Dynamic Web Territories: Web pages rendered in static HTML or dynamically rendered through JavaScript frameworks (including single-page application frameworks such as React, Vue.js, and Angular) and accessed through the Hypertext Transfer Protocol (HTTP) or its secure variant (HTTPS). The unique resource identifier for a web territory is the Uniform Resource Locator (URL) of the page.
2. Content Management System (CMS) Territories: Web pages managed through content management platforms such as WordPress, Drupal, Joomla, or equivalent systems. CMS territories expose plugin APIs and webhook interfaces that enable the runtime node injection unit 110 to inject online price tags through CMS-native plugin mechanisms without requiring modification of raw HTML.
3. Social Media Platform Territories: Posts, stories, reels, and profile pages on social media platforms such as Instagram, TikTok, Facebook, X (formerly Twitter), Pinterest, and equivalent platforms. Each post or story is a distinct digital territory with a unique platform-assigned identifier serving as the resource identifier. Social media platform territories present data input fields through their text caption and hashtag fields and dynamic rendering areas through their media display regions.
4. Live Streaming Territories: Real-time video streaming sessions on platforms such as YouTube Live, TikTok Live, Twitch, Instagram Live, and equivalent platforms. A live streaming territory is identified by the stream session identifier and the channel identifier. Live streaming territories present data input fields through their text chat and metadata fields and dynamic rendering areas through their video player overlays.
5. Messaging and Chat Interface Territories: Conversation threads in messaging platforms such as Telegram channels, WhatsApp groups, iMessage groups, Discord servers, and equivalent platforms. Each conversation thread is a distinct digital territory. The dynamic rendering area of a messaging territory is the message display region in which message content is rendered for recipients.
6. Metaverse and Virtual Space Territories: Three-dimensional virtual environments on platforms such as Roblox, Decentraland, The Sandbox, Horizon Worlds, and equivalent platforms. The unique resource identifier for a metaverse territory is the space coordinate address or the virtual world location identifier. The dynamic rendering area is the three-dimensional rendering viewport of the virtual environment.
7. Augmented Reality (AR) and Wearable Device Territories: Display environments presented through wearable AR devices including smart glasses (such as Meta Ray-Ban smart glasses and equivalent devices) and pendant-form AR displays (such as Apple Vision Pro-class pendant devices and equivalent devices). The unique resource identifier for an AR territory is the device identifier combined with the spatial context descriptor, which encodes the physical location and orientation of the AR device at the time of deployment. The dynamic rendering area of an AR territory is the AR overlay layer superimposed on the wearer's field of vision.

The digital territory scanner unit 90 maintains a persistent territory registry database. For each registered territory, the territory registry stores: the territory type identifier, the unique resource identifier, the last scan timestamp, the last content update timestamp, the authorization token associated with the territory, the injection method identifier, and the exhibitor identifier associated with the territory.

The digital territory scanner unit 90 operates a scheduled scanning loop. In each scan cycle, the scanner unit 90 queries the territory registry for territories that are due for rescan, fetches updated content metadata from each territory through the appropriate territory-specific API or crawling mechanism, and dispatches content to the multimodal context analysis unit 80 for analysis when content updates are detected.

D. Authorization Module (Agent-to-Agent Authorization Module) (within AI Agent Orchestration Unit 70)

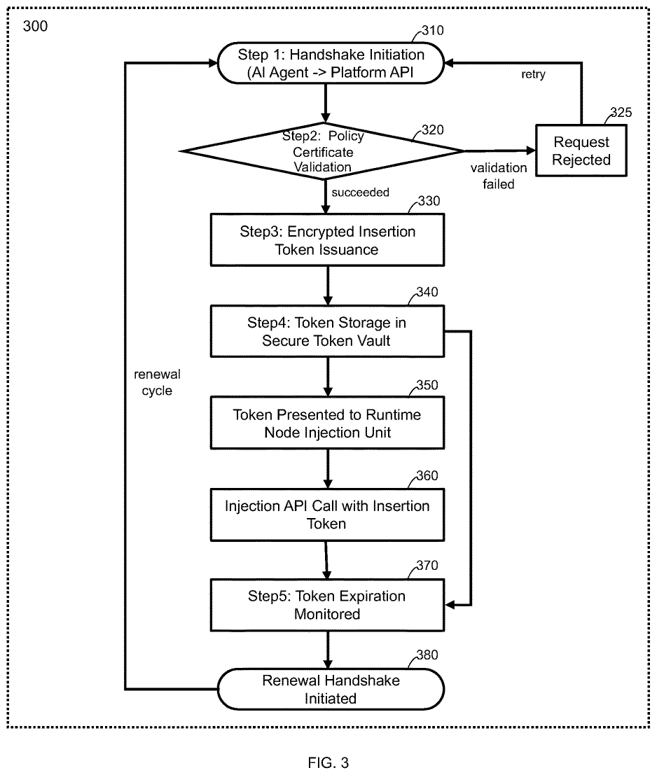

The agent-to-agent authorization module implements the handshaking protocol through which the AI agent obtains insertion rights from platform APIs of the digital territories. The handshaking protocol (300 in FIG. 3) operates as follows, with reference to FIG. 3:

Step 1—Handshake Initiation (310 in FIG. 3): The AI agent orchestration unit 70 transmits a handshake request message to the target platform API. The handshake request message comprises: (a) the AI agent's public key certificate; (b) the exhibitor's platform account identifier; (c) the territory type identifier; and (d) the exhibitor policy certificate (digitally signed by the exhibitor).

Step 2—Policy Certificate Validation (320 in FIG. 3): The target platform API receives the handshake request and validates the exhibitor policy certificate against the platform's own permission rules. The validation process confirms that: (a) the exhibitor policy certificate has not expired; (b) the requested territory type is authorized under the platform's terms of service; (c) the minimum commission rate specified in the exhibitor policy meets the platform's minimum threshold; and (d) the content category filter list does not include categories prohibited by the platform. If the validation fails, the handshake request is rejected (325 in FIG. 3) and the rejection is logged for diagnostic purposes; the AI agent may retry with modified parameters or skip the territory.

Step 3—Token Issuance (330 in FIG. 3): Upon successful validation, the target platform API generates a time-limited encrypted insertion token and transmits it to the AI agent orchestration unit 70 in a handshake response message. The insertion token is a cryptographically signed data structure comprising: (a) the territory identifier; (b) the authorized injection methods; (c) the token validity period; (d) rate limits specifying maximum injections per time unit; and (e) a digital signature by the platform API's private key.

Step 4—Token Storage and Use (340 in FIG. 3): The AI agent orchestration unit 70 stores the insertion token in a secure token vault. The stored token is presented to the runtime node injection unit 110 (350 in FIG. 3) when requesting an injection operation for the associated territory. The runtime node injection unit 110 includes the insertion token in all injection API calls to the platform (360 in FIG. 3), enabling the platform to verify the authorization.

Alternative Authorization Embodiments: In alternative embodiments, the authorization module obtains insertion authorization through mechanisms other than the agent-to-agent handshaking protocol described above. In one such embodiment, the insertion authorization is a user-delegated permission obtained through a client-side agent, such as a browser extension installed on the user's computing device, a mobile application executing on the user's smartphone, or an operating system-level content layer. In this embodiment, the user grants permission to the client-side agent to inject online price tags into the user's rendered view of digital territories, and the authorization module operates within the client-side agent to obtain and manage this user-delegated permission. In another embodiment, the insertion authorization is a pre-configured API key or OAuth token provided by the digital territory platform through a developer registration process, without requiring real-time handshaking for each injection event.

Human-Supervised Optimization Embodiment: In an alternative embodiment, the optimization engine operates in a human-supervised mode, wherein the engine computes optimization scores and generates a ranked list of recommended product-seller-price tuples, and a human operator (such as an exhibitor or platform administrator) reviews and confirms the engine's recommendation before the selected tuple is deployed as an online price tag. In this embodiment, the optimization engine is still considered to “select” the optimized tuple because the substantive selection logic-including candidate retrieval, scoring computation, and ranking—is performed autonomously by the engine; the human operator's role is limited to confirmation or approval of the engine's output.

Step 5—Token Renewal (370, 380 in FIG. 3): The AI agent orchestration unit 70 monitors token expiration timestamps (370) and initiates a renewal handshake (380) before token expiration to ensure continuity of injection authorization.

In embodiments involving multiple AI agents (e.g., in a distributed deployment), the handshaking protocol is extended to support agent-to-agent delegation, wherein a primary AI agent delegates a subset of its insertion rights to secondary AI agents through a cryptographic capability token that encodes the delegated permissions.

### E. Optimization Unit (Triple-Win Optimization Unit) 100

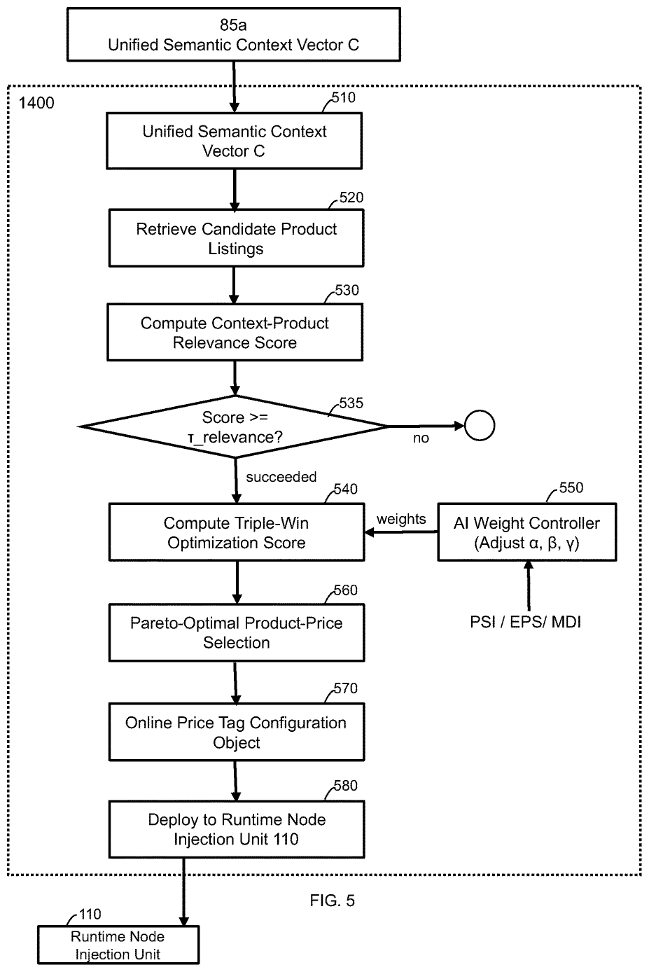

The triple-win optimization unit 100 computes the optimal product-price configuration for deployment within an online price tag at a given digital territory location, given the unified semantic context vector C (510 in FIG. 5) generated by the multimodal context analysis unit 80. The triple-win optimization unit 100 implements a multi-objective optimization framework that simultaneously optimizes for the interests of the exhibitor, the seller, and the buyer.

The triple-win optimization function is defined as:

$$Score ( p , s , π ) = W 1 \cdot R\_exhibitor ( p , s , π ) + W 2 \cdot V\_seller ( p , s , π ) + W 3 \cdot U\_buyer ( p , s , π )$$

(In FIGS. 5, W1, W2, and W3 are denoted as α, β, and γ, respectively.)

where: —p denotes a product item from the product database—s denotes a seller offering product p—π denotes the price at which seller s offers product p (as determined by the reverse auction mechanism of the '846 patent)—R_exhibitor (p, s, π) is the expected exhibitor revenue component, computed as the product of the probability of purchase P_purchase(p, C) given context vector C and the exhibition fee f_exhibitor(p, s, π)-V_seller (p, s, x) is the seller transaction volume component, computed as the expected transaction value adjusted by the seller's margin preference function-U_buyer(p, s, π) is the buyer utility component, computed as the estimated value-to-price ratio of product p at price x in the context represented by C, incorporating quality signals from historical buyer satisfaction data-W1, W2, W3 are non-negative weight coefficients satisfying W1+W2+W3=1

The triple-win optimization unit 100 includes an AI weight controller (550 in FIG. 5) that dynamically adjusts the weight coefficients W1, W2, W3 based on the following system state parameters:
Platform Saturation Index (PSI): When the density of online price tags within a territory type is high (high PSI), the AI weight controller increases W3 (buyer utility weight) to improve buyer experience and maintain click-through rates.
Exhibitor Performance Score (EPS): The exhibitor performance score is a scalar value computed by the closed-loop feedback unit 130 reflecting the historical transaction conversion rate of online price tags deployed in territories attributed to the exhibitor. When EPS is high, the AI weight controller may modestly increase W1 to reward high-performing exhibitors.
Market Demand Index (MDI): The market demand index reflects current demand levels for product categories relevant to the current context. When MDI is high for a category, the AI weight controller may increase W2 to allocate more value to seller volume objectives.
System Revenue Target Compliance: When system revenue is below periodic targets, the AI weight controller adjusts weights to increase overall transaction probability.

The triple-win optimization unit 100 retrieves candidate product listings (520 in FIG. 5) from a product database that stores products offered by sellers who have registered with the system. For each candidate (p, s, x) tuple, the triple-win optimization unit 100 computes a context-product relevance score (530 in FIG. 5) using the cosine similarity between the unified semantic context vector C and the product embedding vector P_embed(p) stored in the product database. Candidates with context-product relevance scores below a configured threshold t_relevance are filtered out (535 in FIG. 5) before the triple-win optimization score is computed (540 in FIG. 5). This context-relevance filtering step ensures that online price tags are only deployed for products that are semantically relevant to the surrounding content, distinguishing the present system from generic advertisement recommendation systems.

The Pareto-optimal product-price selection (560 in FIG. 5) identifies the configuration that maximizes the triple-win optimization score across all non-dominated solutions. The output of the triple-win optimization unit 100 is an online price tag configuration object (570 in FIG. 5) comprising: the selected product identifier, the selected seller identifier, the initial display price x, the context-product relevance score, the computed optimization score, and the set of weight coefficients W1, W2, W3 used for the optimization. The configuration is then deployed to the runtime node injection unit 110 (580 in FIG. 5).

### F. Runtime Node Injection Unit 110

The runtime node injection unit 110 is responsible for injecting the online price tag as a sandboxed transaction node into the digital territory, using the injection method appropriate for the territory type. The online price tag injected by the runtime node injection unit 110 is the same transaction node structure as defined in the '846 patent, extended with metadata fields for multimodal binding annotations and telemetry collection.

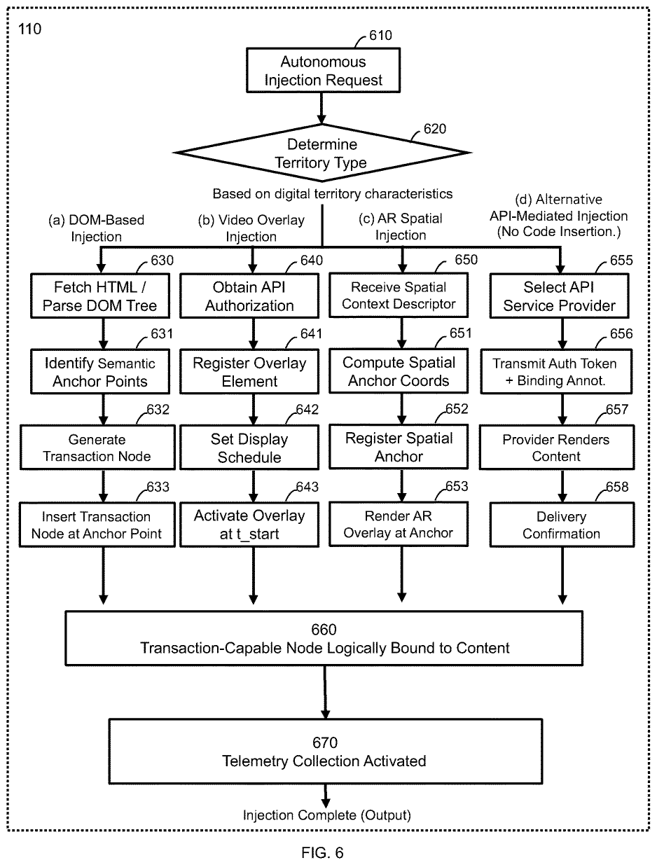

The runtime node injection unit 110 supports three primary injection pathways, selected based on the territory type (620 in FIG. 6). The injection process is initiated by an injection request (610 in FIG. 6):

DOM Injection Pathway (630-633 in FIG. 6): For web-based digital territories (territory types: static/dynamic web, CMS), the runtime node injection unit 110 performs Document Object Model (DOM) injection. The injection process comprises: (a) fetching the HTML content of the target web page and parsing the DOM tree (630 in FIG. 6); (b) identifying semantic anchor points within the DOM tree (631 in FIG. 6) at which the online price tag widget should be inserted, using the binding annotations generated by the multimodal context analysis unit 80 (e.g., an image element that the image analysis module 82 identified as depicting the matched product); (c) generating the sandboxed online price tag widget code (632 in FIG. 6), which is a self-contained sandboxed script element (implemented using the HTML <iframe sandbox> attribute or an equivalent sandboxed execution context) that renders the online price tag and manages its interaction events; and (d) inserting the online price tag widget code at the identified anchor point in the DOM (633 in FIG. 6) and transmitting the modified page content back to the CMS or web server for serving to end users. For CMS territories, the DOM injection is performed through the CMS plugin API, which provides native hooks for inserting content elements at specified positions within the content tree.

The online price tag widget rendered in the DOM injection pathway displays: the matched product image, the product name, the current reverse-auction lowest price (updated in real time through the update unit 30 of the '846 patent), the seller identifier, and a purchase action element. The widget is rendered in a sandboxed execution context to prevent interference with the host page's scripts and styles.

Video Overlay Injection Pathway (640-643 in FIG. 6): For live streaming and social media video territories, the runtime node injection unit 110 performs video overlay layer injection. The injection process comprises: (a) obtaining API authorization from the platform through the agent-to-agent authorization module (640 in FIG. 6); (b) registering the online price tag widget as a video overlay element with the platform's overlay API (641 in FIG. 6); (c) specifying the display schedule for the overlay element as a list of (t_start, t_end, spatial_region) tuples derived from the timestamp-indexed binding annotations generated by the video analysis module 83 and the product mention events generated by the audio analysis module 84 (642 in FIG. 6); (d) providing the online price tag widget content as a responsive component that adapts to the overlay rendering context; and (e) activating the overlay element, causing the platform to render the online price tag widget above the video frame at the specified timestamps and spatial regions (643 in FIG. 6).

Upon completion of all three injection pathways, the online price tag is logically bound to the content context (660 in FIG. 6) and telemetry collection is activated (670 in FIG. 6) to monitor viewport visibility, dwell time, and user interaction signals.

The video overlay injection pathway implements logical binding, wherein the online price tag is semantically and temporally bound to the content context rather than being statically embedded. Specifically, the online price tag appears and disappears in synchronization with the visibility of the matched product within the video content, as determined by the video analysis module 83. This logical binding ensures that the online price tag is displayed only when and where it is contextually relevant, improving the user experience and increasing purchase conversion probability.

AR Spatial Injection Pathway (650-653 in FIG. 6): For AR and wearable device territories, the runtime node injection unit 110 performs AR layer binding. The injection process comprises: (a) receiving the AR territory's spatial context descriptor, which includes the device's current position (GPS coordinates or indoor positioning data), orientation (quaternion from the device's inertial measurement unit), and field-of-view parameters (650 in FIG. 6); (b) receiving object detection annotations from the image analysis module 82 identifying physical objects in the AR device's camera feed that correspond to products in the product database; (c) computing spatial anchor coordinates for the online price tag overlay by transforming the two-dimensional bounding box of the detected object from camera image space into three-dimensional world space using the device's pose data and depth estimation (651 in FIG. 6); (d) registering the online price tag as a spatial anchor in the AR device's spatial anchor registry (652 in FIG. 6); and (e) rendering the online price tag as an AR overlay element positioned at the computed spatial anchor coordinates, causing the online price tag to appear spatially attached to the physical object in the wearer's field of view (653 in FIG. 6).

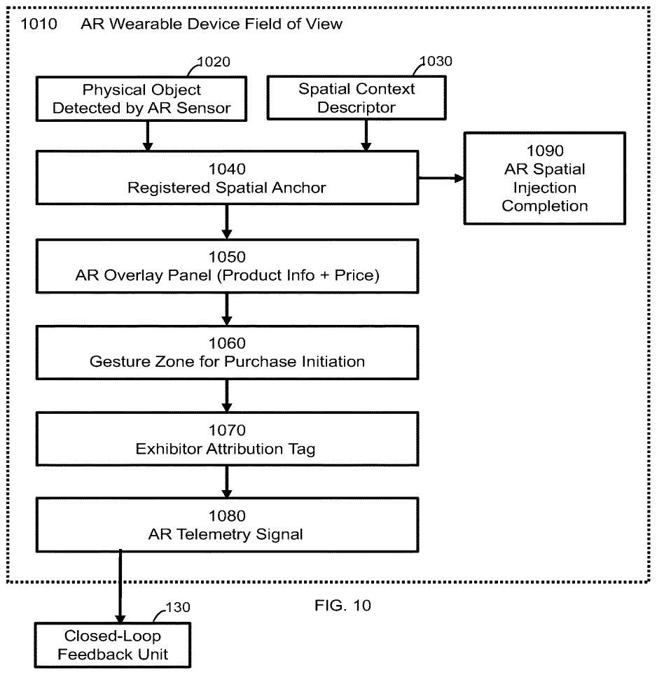

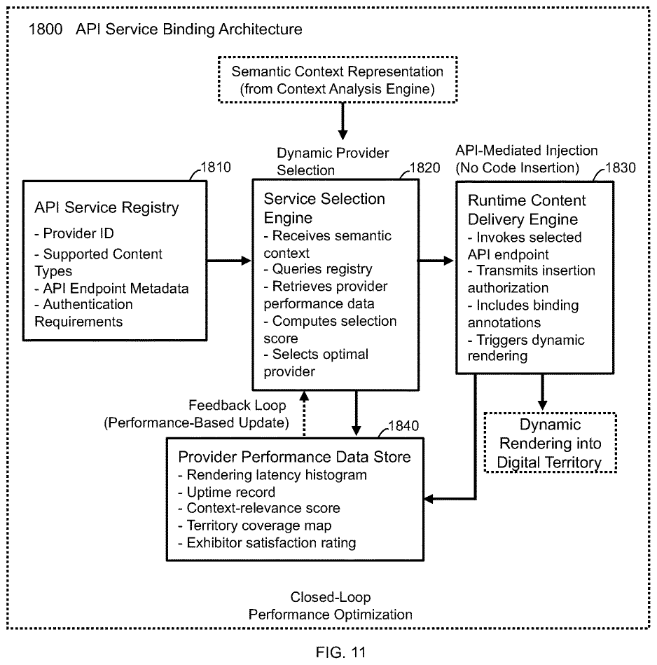

The AR spatial injection pathway renders the online price tag as a floating panel in the AR display, positioned adjacent to the detected physical object (as illustrated in FIG. 10). The panel displays the product name, current price, seller information, and an interaction gesture zone. The wearer can initiate a purchase by performing a designated gesture (e.g., a pinch gesture or a gaze dwell) over the interaction gesture zone.

### G. AI Operational Cost Accounting Unit 120

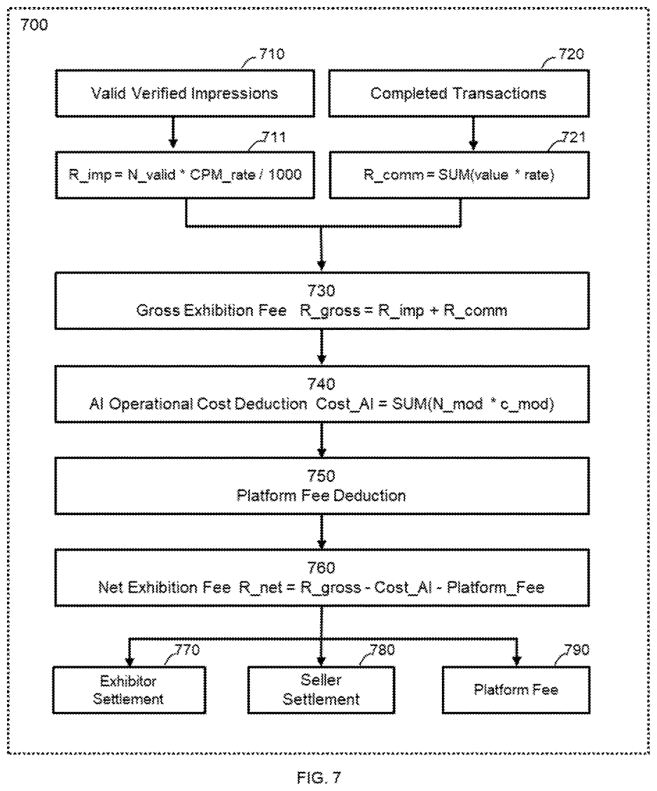

The AI operational cost accounting unit 120 computes the AI processing costs incurred during multimodal analysis of each digital territory and deducts these costs from the gross exhibition fee payable to the exhibitor, as shown in the revenue settlement architecture of FIG. 7.

The AI operational cost for a given territory analysis session is computed as:

$$Cost\_AI = N\_text \cdot c\_text + N\_image \cdot c\_image + N\_video \cdot c\_video + N\_audio \cdot c\_audio$$

where: —N_text is the number of text analysis operations performed (measured in tokens processed)—N_image is the number of image analysis operations performed (measured in image frames analyzed)—N_video is the number of video frame analysis operations performed—N audio is the number of audio analysis operations performed (measured in seconds of audio processed)—c_text, c_image, c_video, c_audio are per-unit cost coefficients for each modality, wherein c_text<c_image<c_video≈c_audio, reflecting the relative computational intensity of each modality

The cost coefficients are configurable parameters that may be adjusted by the system administrator. In a preferred embodiment, the cost coefficients are set such that the AI operational cost does not exceed a fixed percentage of the gross exhibition fee for any single deployment event. If the computed Cost_AI would cause the net exhibition fee to fall below the exhibitor's minimum commission rate threshold as specified in the exhibitor policy, the AI agent orchestration unit 70 selects a lower-cost analysis configuration (e.g., text-only analysis) for the territory in question.

The AI operational cost accounting unit 120 generates a detailed cost breakdown report for each exhibitor settlement period, itemizing the AI operational costs by territory, by modality, and by analysis session.

H. Hybrid Revenue Computation Module (within AI Cost Accounting Unit 120)

The hybrid revenue computation module within the AI cost accounting unit 120 computes the total exhibition fee payable to the exhibitor under the hybrid revenue model. The hybrid revenue model combines two revenue components:

Referring to FIG. 7, the revenue distribution and settlement architecture (700 in FIG. 7) operates as follows. Valid verified impressions (710 in FIG. 7) and completed transactions (720 in FIG. 7) serve as the two primary revenue inputs.

Impression-Based Rent Component (R_impression): The exhibitor earns a rent payment for valid verified exposures of the online price tag, regardless of whether a purchase is completed. The impression-based rent component is computed as (711 in FIG. 7):

$$R\_impression = N\_valid \_impression \cdot CPM\_rate / 1000$$

where N_valid_impressions is the number of valid impressions verified by the valid exposure verification subsystem (described below), and CPM_rate is the cost-per-mille rate applicable to the territory type and product category.

A valid impression is defined as an exposure event in which: (a) the online price tag widget has been rendered within the viewport of the end user's display device; (b) the online price tag widget has been continuously visible within the viewport for at least a minimum dwell time threshold T_min_dwell (configurable, default 2 seconds); and (c) the end user's device has transmitted at least one interaction signal (e.g., a scroll event, a mouse movement, a touch event, or a gaze fixation signal) during the dwell period, confirming that the end user was actively engaged with the content. Validity is determined by a telemetry script embedded within the online price tag widget that collects viewport visibility data, dwell time, and interaction signals and transmits them to a telemetry collection endpoint.

Performance-Based Commission Component (R_commission): The exhibitor earns an additional performance-based component upon completion of a transaction through the online price tag. The performance-based commission component is computed as (721 in FIG. 7):

$$R\_commission = Σ ( transaction\_value \_i \cdot commission\_rate \_i )$$

where the sum is over all completed transactions attributed to online price tags deployed under the exhibitor's exhibitor identifier during the settlement period, transaction_value_i is the value of transaction i, and commission_rate_i is the applicable commission rate for the product category of transaction i.

The total gross exhibition fee is (730 in FIG. 7): R_gross=R_impression+R_commission

AI operational costs are deducted from the gross exhibition fee (740 in FIG. 7), followed by platform fee deduction (750 in FIG. 7).

The net exhibition fee payable to the exhibitor is (760 in FIG. 7): R_net=R_gross−Cost_AI−Platform Fee

where Platform_Fee is the system operator's platform fee. The net exhibition fee is then distributed among three parties: exhibitor settlement (770 in FIG. 7), seller settlement (780 in FIG. 7), and platform fee (790 in FIG. 7).

### I. Closed-Loop Feedback Unit 130

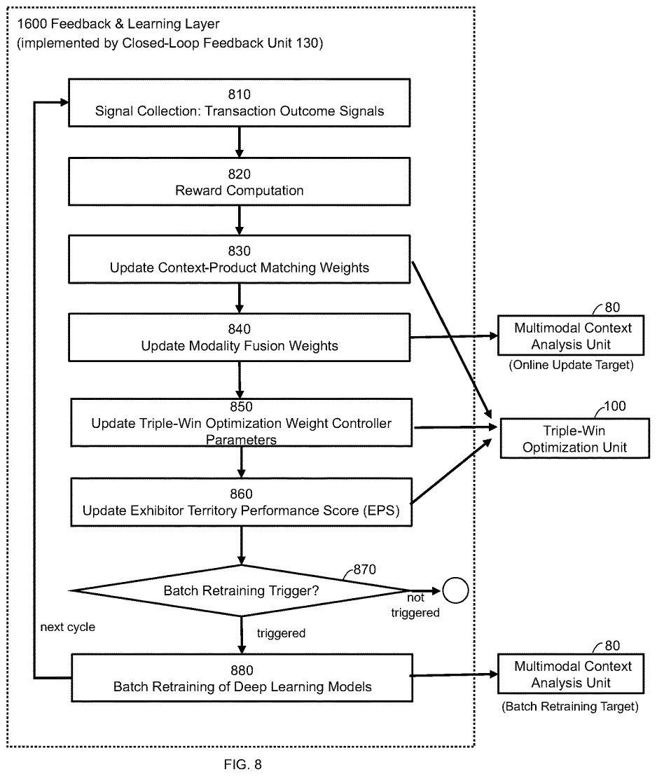

The closed-loop feedback unit 130 implements a reinforcement learning framework for continuous self-improvement of the multimodal context analysis unit 80 and the triple-win optimization unit 100. The closed-loop feedback unit 130 operates as follows, with reference to FIG. 8:

Referring to FIG. 8, the closed-loop feedback and reinforcement learning process operates as follows.

Signal Collection (810 in FIG. 8): The closed-loop feedback unit 130 continuously collects transaction outcome signals from the processing unit 40 of the '846 patent and from external data sources. Transaction outcome signals include: (a) purchase completion events (positive reward signal); (b) purchase abandonment events (weak negative reward signal); (c) buyer satisfaction ratings submitted post-purchase (positive or negative reward signal depending on rating value); (d) product return events (strong negative reward signal); (e) click-through events on the online price tag widget (positive reward signal of lesser magnitude than purchase completion); and (f) valid impression events from the telemetry collection endpoint.

Reward Computation (820 in FIG. 8): The closed-loop feedback unit 130 computes a scalar reward signal R for each transaction interaction event. The reward signal is computed as a weighted combination of the observed outcome signals, with weights reflecting the long-term value of each signal type for the system's optimization objectives.

Model Parameter Updates: The closed-loop feedback unit 130 applies the computed reward signals to update the following model parameters:
1. Context-Product Matching Weights (830 in FIG. 8): The similarity weights used by the triple-win optimization unit 100 to compute context-product relevance scores are updated through a policy gradient method, increasing the relevance scores assigned to product-context pairs that have historically resulted in high reward signals and decreasing the scores assigned to pairs that have resulted in low reward signals.
2. Modality Fusion Weights (840 in FIG. 8): The modality-specific weights in the multimodal fusion module 85 are updated to increase the contribution of modalities that have provided the most predictive context signals for the current territory type and product category.
3. Triple-Win Optimization Weight Controller Parameters (850 in FIG. 8): The parameters of the AI weight controller in the triple-win optimization unit 100 are updated to improve the accuracy of weight adjustment recommendations based on system state parameters.
4. Exhibitor Territory Performance Score (860 in FIG. 8): The closed-loop feedback unit 130 maintains an exhibitor performance score (EPS) for each exhibitor, updated after each settlement period to reflect the conversion rate and buyer satisfaction metrics associated with online price tags deployed in territories attributed to that exhibitor. The EPS is used by the triple-win optimization unit 100's AI weight controller as described in Section III.E above.

Batch Retraining Trigger (870 in FIG. 8): In addition to the online parameter updates described above, the closed-loop feedback unit 130 performs periodic batch retraining (880 in FIG. 8) of the deep learning models in the multimodal context analysis unit 80 using accumulated historical data. The batch retraining cycle is executed on a configurable schedule (e.g., weekly) and involves retraining the object detection model, the visual embedding model, the text embedding model, and the multimodal fusion network using a dataset comprising all context-product-outcome tuples collected during the preceding period.

### IV. Example Operation: Web-Based Territory

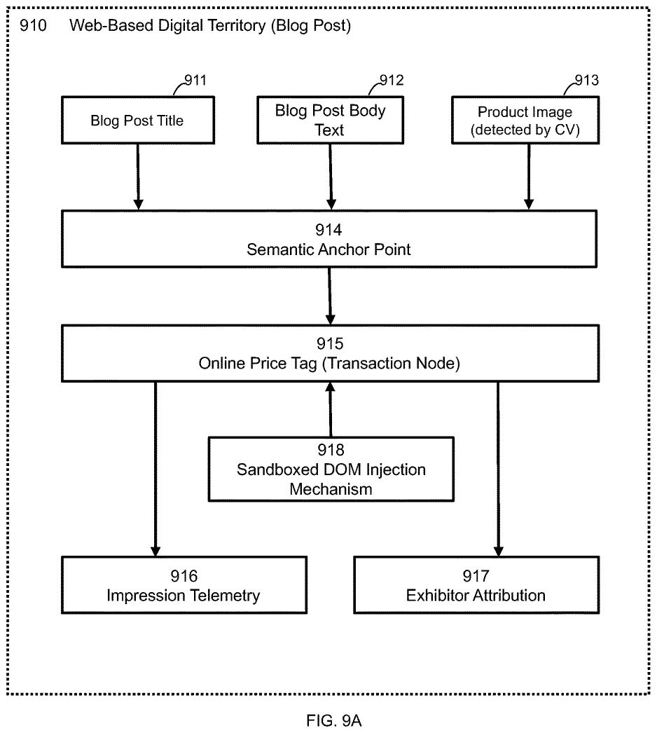

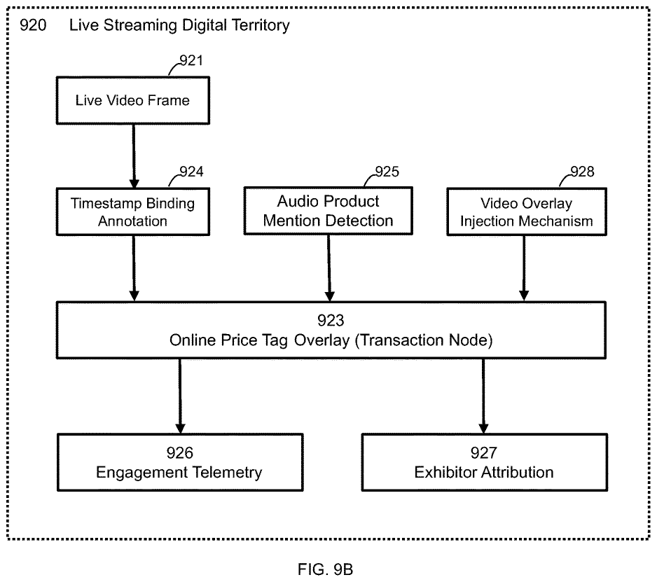

The following example illustrates the operation of the AI agent-driven online shopping support system according to an embodiment of the present invention in the context of a web-based territory (a blog post), as illustrated in FIG. 9A. The web-based digital territory is indicated at 910 in FIG. 9A. The blog post title is shown at 911 in FIG. 9A, the blog post body text at 912, and the product image detected by computer vision at 913. The semantic anchor point generated from both text and image analysis is shown at 914. The online price tag widget injected at the anchor point is shown at 915. Impression telemetry is indicated at 916, exhibitor attribution at 917, and the sandboxed DOM injection mechanism at 918.
1. An exhibitor registers with the system and sets an exhibitor policy specifying: minimum commission rate of 3%, authorized content categories including “electronics” and “home goods”, authorized territory types including web and social media, and maximum AI cost budget of 5% of gross exhibition fees.
2. The AI agent orchestration unit 70 registers the exhibitor's blog's RSS feed URL as a monitored territory in the territory registry database.
3. The digital territory scanner unit 90 detects a new blog post published at a URL on the exhibitor's blog. The scanner unit 90 fetches the post content and dispatches it to the multimodal context analysis unit 80.
4. The text analysis module 81 processes the post text, identifying that the post discusses home office ergonomics and references specific types of ergonomic chairs and monitor stands. The text analysis module 81 generates a text semantic feature vector T reflecting these semantic concepts.
5. The image analysis module 82 processes the images embedded in the post, detecting an ergonomic office chair in one image and a dual-monitor desk setup in another. The image analysis module 82 generates visual semantic feature vectors V for each detected product-related object.
6. The multimodal fusion module 85 combines T and V into a unified semantic context vector C.
7. The triple-win optimization unit 100 receives C, retrieves candidate ergonomic chair and monitor stand products from sellers who have registered with the system, computes context-product relevance scores for each candidate, filters out low-relevance candidates, and computes triple-win optimization scores for the remaining candidates. The optimization selects an ergonomic office chair product offered by a seller at a price of $349 as the optimal product-price configuration, with W1=0.4, W2=0.3, W3=0.3 under the current system state.
8. The agent-to-agent authorization module obtains or verifies a valid insertion token for the exhibitor's blog platform.
9. The runtime node injection unit 110 performs DOM injection, inserting a sandboxed online price tag widget adjacent to the image of the detected ergonomic chair, logically binding the online price tag to the image content.
10. End users who subsequently visit the exhibitor's blog post see the online price tag widget adjacent to the chair image. The widget displays the ergonomic chair product, the current reverse-auction price from competing sellers, and a purchase action element.
11. An end user views the online price tag widget for 4.5 seconds (exceeding T_min_dwell) and interacts with the surrounding content. The telemetry script records a valid impression event. The impression-based rent component of the exhibition fee is incremented.
12. The end user activates the purchase action element on the online price tag widget. The processing unit 40 of the '846 patent processes the purchase. The performance-based commission component of the exhibition fee is calculated and attributed to the exhibitor.
13. The closed-loop feedback unit 130 receives the purchase completion event and updates the context-product matching weights to increase the relevance score for the ergonomic chair product category in the context of home office ergonomics content.

### V. Example Operation: Live Streaming Territory

A second example illustrates operation in a live streaming territory, as illustrated in FIG. 9B. The live streaming digital territory is indicated at 920 in FIG. 9B. The live video frame presented by the streamer is shown at 921 in FIG. 9B, the online price tag overlay widget at 923, the timestamp binding annotation at 924, the audio product mention detection at 925, engagement telemetry at 926, exhibitor attribution at 927, and the video overlay injection mechanism at 928.
1. The exhibitor hosts a live streaming session on a video platform. The live stream is registered as a territory in the territory registry.
2. The audio analysis module 84 monitors the live audio stream in real time. At timestamp T=00:12:34, the exhibitor says: “I've been using this wireless keyboard for three months now and it's really changed my workflow.” The audio analysis module 84 generates a product mention event with the detected term “wireless keyboard” at timestamp 00:12:34.
3. Simultaneously, the video analysis module 83 detects a wireless keyboard product in the video frame beginning at timestamp 00:12:30, generating a binding annotation with t start=00:12:30, t_end=00:13:15.
4. The multimodal fusion module 85 combines the audio product mention event and the video binding annotation with a text analysis of the concurrent live chat messages (which contain multiple mentions of “keyboard” and “which keyboard?”) to generate a unified semantic context vector C with high relevance to wireless keyboard products.
5. The triple-win optimization unit 100 selects an optimal wireless keyboard product-price configuration.
6. The runtime node injection unit 110 registers an online price tag overlay element with the platform's overlay API, scheduled to appear from timestamp 00:12:30 to 00:13:15 in the spatial region corresponding to the keyboard's position in the video frame.
7. Viewers of the live stream see the online price tag appear as an overlay on the video at the moment the exhibitor mentions the keyboard, positioned near the keyboard's location in the video frame. Viewers who wish to purchase can interact with the overlay to initiate a transaction through the processing unit 40 of the '846 patent.

### VI. Example Operation: Ar/Wearable Territory

A third example illustrates operation in an AR/wearable device territory, as illustrated in FIG. 10. The AR wearable device field of view is shown at 1010 in FIG. 10. The physical object detected by the AR sensor is shown at 1020, the spatial context descriptor at 1030, the registered spatial anchor at 1040, the AR overlay panel displaying product information at 1050, the gesture zone for purchase initiation at 1060, the exhibitor attribution tag at 1070, the AR telemetry signal at 1080, and the AR spatial injection completion at 1090.
1. The exhibitor is a retail store owner who has authorized the system to deploy online price tags within the store's AR territory (accessible to customers wearing AR glasses).
2. A customer wearing AR glasses enters the store (1010 in FIG. 10). The AR device identifies the territory through the store's spatial context descriptor (1030 in FIG. 10).
3. The camera feed from the AR device is processed by the image analysis module 82, which detects a specific model of coffee maker on a store shelf (1020 in FIG. 10).
4. The triple-win optimization unit 100 identifies the coffee maker product and competing sellers offering it online, and selects an optimal seller-price configuration that satisfies the triple-win optimization function, potentially offering the customer a price that includes a component of offline-to-online price matching.
5. The runtime node injection unit 110 registers a spatial anchor (1040 in FIG. 10) for the online price tag adjacent to the detected coffee maker, completing the AR spatial injection (1090 in FIG. 10).
6. The customer sees a floating AR overlay panel (1050 in FIG. 10) next to the coffee maker in their AR view, displaying the product name, current online price from competing sellers, and a gesture-activated purchase element. The gesture zone (1060 in FIG. 10) enables purchase initiation through pinch or gaze dwell.
7. The customer performs a pinch gesture to initiate purchase. The processing unit 40 processes the purchase, and the exhibition fee is attributed to the store exhibitor's exhibitor identifier (1070 in FIG. 10). AR telemetry (1080 in FIG. 10) records the interaction event for the closed-loop feedback unit 130.
   VII. Differentiation from Generic Advertisement Systems

The present invention is distinguished from generic advertisement recommendation systems in the following material respects:
1. Transaction Node Architecture: The core operative element of the present invention is the online price tag as defined in the '846 patent-a transaction node that enables direct purchase execution at the point of content encounter. Unlike advertisement recommendation systems, which deliver impression-based display advertisements that redirect users to external websites, the online price tag is a self-contained transaction node that incorporates real-time reverse auction price discovery, purchase processing, and exhibitor attribution within a single embedded element.
2. Exhibitor Attribution Mechanism: The present invention maintains the exhibitor identification framework of the '846 patent, wherein each online price tag carries the digital identity of the exhibitor whose content contextualizes the tag. This attribution is not merely a tracking parameter but is the mechanism by which exhibition fees are computed and issued. Generic advertisement systems do not disclose or enable an exhibitor identification mechanism tied to content creator identity and linked to a transaction-triggered reward structure.
3. Multimodal Logical Binding: The present invention performs logical binding of the online price tag to the semantic and temporal context of the surrounding content (not merely physical insertion into a content slot). The logical binding is implemented through timestamp-indexed binding annotations and spatial anchor coordinates that cause the online price tag to be presented only when and where its product context is semantically relevant. This is materially distinct from behavioral targeting or contextual advertising systems that match advertisement content to user profiles or page-level keywords.
4. Triple-Win Multi-Objective Optimization: The triple-win optimization function of the present invention simultaneously optimizes for exhibitor revenue, seller transaction volume, and buyer utility. Generic recommendation systems optimize for a single objective (typically advertiser return on ad spend or platform revenue). The multi-objective nature of the present invention's optimization reflects the three-party nature of the exhibition commerce model and produces qualitatively different optimization behavior.
5. Agent-to-Agent Authorization: The agent-to-agent handshaking protocol of the present invention is a specific technical mechanism for an AI agent to obtain machine-readable authorization from platform APIs for the purpose of online price tag injection. This is distinct from user-level authentication flows and is specific to the multi-agent architecture of the present invention.

### Alternative Embodiment: API-Based Dynamic Service Binding

In an alternative embodiment, the AI agent system of the present invention operates without physically injecting a transaction node into the exhibitor's digital territory. Instead, the AI agent implements a dynamic API service binding model, wherein the system maintains a registry of API service providers offering product information and transaction processing capabilities. When a product exhibition opportunity is identified through semantic context analysis, the AI agent selects an optimal API service provider based on contextual factors and invokes the provider's endpoint in real time to dynamically render exhibition content that is functionally equivalent to an embedded transaction node. Provider performance is tracked and fed back to improve provider-context matching.

In a further alternative, the system operates in a hybrid mode combining embedded transaction nodes for high-traffic contexts with API-based dynamic binding for long-tail contexts. This alternative embodiment extends the scope of the invention to cover scenarios where direct node injection is technically impractical or economically inefficient, while the core inventive concept-AI agent-mediated, context-aware product exhibition with optimization-remains unchanged.

What is claimed is:

1. An AI agent-driven online shopping support system comprising: one or more processors and non-transitory computer-readable memory storing instructions that, when executed by the one or more processors, implement: a digital territory scanner configured to autonomously scan one or more digital territories, each digital territory being a remotely accessible online environment having a unique resource identifier and a dynamic rendering area, wherein said digital territory does not require physical proximity between a user and a dedicated on-site commerce display device; a context analysis engine configured to analyze content within the scanned digital territories across one or more modalities comprising at least one of: text data, image data, video data, and audio data, and to generate therefrom a semantic context representation of the analyzed content; an authorization module configured to obtain an insertion authorization from a target digital territory permitting injection of an online price tag into the dynamic rendering area of the target digital territory; an optimization engine configured to receive the semantic context representation and, from one or more candidate product-seller-price tuples retrieved from a product database, select an optimized tuple by computing for each candidate an optimization score based on one or more commerce performance components; a runtime node injection engine configured to inject, using the insertion authorization, an online price tag as a transaction node into the dynamic rendering area of the target digital territory, wherein the online price tag is logically bound to the content of the target digital territory through binding annotations generated by the context analysis engine; and an issue unit configured to compute an exhibition fee attributable to an exhibitor whose exhibitor identifier is associated with the injected online price tag, wherein the exhibition fee comprises at least one of: an impression-based component computed from verified valid exposures and a performance-based component computed from completed transactions processed through the online price tag.

2. The system of claim 1, wherein the authorization module is configured to execute a handshaking protocol with a platform API of the target digital territory, the handshaking protocol comprising: transmitting a handshake request message to the platform API, the handshake request message comprising an AI agent public key certificate and an exhibitor policy certificate signed by the exhibitor, the exhibitor policy certificate specifying at least a minimum commission rate threshold, authorized content category filters, and authorized territory type permissions; receiving, from the platform API, an encrypted insertion token upon the platform API's validation of the exhibitor policy certificate against platform-specific permission rules; and storing the encrypted insertion token in a secure token vault and presenting the encrypted insertion token to the runtime node injection engine for use in injection API calls.

3. The system of claim 1, wherein the context analysis engine is a multimodal context analysis engine comprising: a text analysis module configured to perform natural language processing on text content within the scanned digital territory, including named entity recognition for product names, brand names, and product attributes, and to output a text semantic feature vector; an image analysis module configured to perform object detection and visual embedding on image content within the scanned digital territory, and to output a visual semantic feature vector and a set of detected object annotations each comprising an object identifier, a confidence score, and a bounding box; a video analysis module configured to perform temporal object detection on video content within the scanned digital territory and to generate timestamp-indexed binding annotations each comprising a product identifier, a start timestamp, an end timestamp, a confidence score, and a spatial region within a video frame; an audio analysis module configured to perform speech-to-text recognition on audio content of a digital territory and to generate product mention events each comprising a detected product or brand name, a timestamp within the audio stream, a confidence score, and a contextual phrase window surrounding the mention; and a multimodal fusion module configured to combine the text semantic feature vector, the visual semantic feature vector, and signals from the audio analysis module into a unified semantic context vector as the semantic context representation using learned modality-specific weights, the multimodal fusion module being further configured to incorporate signals from the product mention events into the semantic context representation.

4. The system of claim 3, wherein the one or more digital territories comprise a live streaming digital territory, and the runtime node injection engine is configured to perform video overlay injection by: registering the online price tag as a video overlay element with a video platform overlay API; specifying a display schedule for the overlay element as a list of time intervals derived from the timestamp-indexed binding annotations generated by the video analysis module; and causing the online price tag to appear as a transparent overlay above the video content during the specified time intervals and at spatial positions corresponding to the spatial regions defined in the timestamp-indexed binding annotations.

5. The system of claim 1, wherein the one or more digital territories comprise an augmented reality wearable device digital territory, and the runtime node injection engine is configured to perform AR spatial injection by: receiving a spatial context descriptor from the AR wearable device comprising a device position, a device orientation, and field-of-view parameters; receiving object detection annotations identifying a physical object in the camera feed of the AR wearable device that corresponds to a product in the product database; computing spatial anchor coordinates for the online price tag by transforming a two-dimensional bounding box of the detected physical object from camera image space into three-dimensional world space using the device's pose data; and rendering the online price tag as an AR overlay element positioned at the computed spatial anchor coordinates, causing the online price tag to appear spatially attached to the detected physical object in the wearer's field of view.

6. The system of claim 1, wherein the optimization engine is a triple-win optimization engine configured to compute the optimization score as a weighted sum of an exhibitor revenue component, a seller transaction volume component, and a buyer utility component, the system further comprising: an AI weight controller configured to dynamically adjust weight coefficients W1, W2, W3 applied to the exhibitor revenue component, the seller transaction volume component, and the buyer utility component, respectively, based on system state parameters comprising at least: a platform saturation index reflecting the density of online price tags within the target territory type; an exhibitor performance score reflecting a historical transaction conversion rate of online price tags attributed to the exhibitor; and a market demand index reflecting current demand levels for product categories relevant to the semantic context representation; and a context-product relevance filter configured to compute, for each candidate product, a relevance score as a cosine similarity between the semantic context representation and a product embedding vector, and to exclude from the optimization candidates having a relevance score below a configured threshold.

7. The system of claim 1, further comprising: an AI operational cost accounting module configured to compute an AI processing cost for each digital territory analysis session as a sum of per-unit costs for text analysis operations, image analysis operations, video analysis operations, and audio analysis operations, wherein the per-unit cost for text analysis operations is less than the per-unit cost for image analysis operations, and the per-unit cost for image analysis operations is less than the per-unit cost for video analysis operations; and wherein the issue unit is further configured to deduct the AI processing cost from a gross exhibition fee to compute a net exhibition fee payable to the exhibitor.

8. The system of claim 1, further comprising: a closed-loop feedback unit configured to: collect transaction outcome signals comprising purchase completion events, buyer satisfaction ratings, product return events, and click-through events attributed to online price tags injected by the runtime node injection engine; compute a scalar reward signal for each transaction interaction event based on the collected outcome signals; update context-product matching weights of the optimization engine through a policy gradient method based on the computed reward signals; update modality-specific fusion weights of the context analysis engine based on the predictive utility of each modality for the observed outcomes; update an exhibitor performance score for the exhibitor based on conversion rate and buyer satisfaction metrics observed during a settlement period; and perform periodic batch retraining of deep learning models within the context analysis engine using a dataset comprising context-product-outcome tuples accumulated during a preceding retraining period, the deep learning models comprising at least an object detection model, a visual embedding model, a text embedding model, and a multimodal fusion network.

9. A computer-implemented method for AI agent-driven autonomous deployment of online price tags across digital territories, the method comprising: autonomously scanning, by a digital territory scanner executing on a processor, one or more digital territories, each digital territory being a remotely accessible online environment having a unique resource identifier and a dynamic rendering area, wherein said digital territory does not require physical proximity between a user and a dedicated on-site commerce display device; analyzing, by a context analysis engine executing on the processor, content within a target digital territory across one or more modalities comprising at least one of: text data, image data, video data, and audio data, and generating therefrom a semantic context representation; obtaining, by an authorization module executing on the processor, an insertion authorization from the target digital territory permitting injection of an online price tag into the dynamic rendering area of the target digital territory; selecting, by an optimization engine executing on the processor, from one or more candidate product-seller-price tuples retrieved from a product database, an optimized tuple by computing for each candidate an optimization score based on one or more commerce performance components; injecting, by a runtime node injection engine executing on the processor and using the insertion authorization, an online price tag as a transaction node into the dynamic rendering area of the target digital territory, wherein the online price tag is logically bound to the content of the target digital territory through binding annotations derived from the context analysis; and computing an exhibition fee attributable to an exhibitor whose exhibitor identifier is associated with the injected online price tag, the exhibition fee comprising at least one of: an impression-based component computed from verified valid exposures and a performance-based component computed from completed transactions processed through the online price tag.

10. The method of claim 9, wherein obtaining the insertion authorization comprises executing a handshaking protocol with a platform API of the target digital territory, comprising: transmitting a handshake request message to the platform API comprising an AI agent public key certificate and an exhibitor policy certificate signed by the exhibitor, the exhibitor policy certificate specifying at least a minimum commission rate threshold and authorized territory type permissions; receiving from the platform API an encrypted insertion token upon validation of the exhibitor policy certificate; and storing the encrypted insertion token in a secure token vault for presentation to the runtime node injection engine.

11. The method of claim 9, wherein analyzing content across one or more modalities comprises: performing natural language processing on text content of the target digital territory to extract named entities comprising product names, brand names, and product attributes, and generating a text semantic feature vector; performing object detection on image content of the target digital territory to identify product-related objects and generate a visual semantic feature vector and detected object annotations; performing temporal object detection on video content of the target digital territory to generate timestamp-indexed binding annotations comprising a product identifier, a start timestamp, an end timestamp, and a spatial region within a video frame; and combining the text semantic feature vector and the visual semantic feature vector through a multimodal fusion module using learned modality-specific weights to produce the semantic context representation; performing speech-to-text recognition on audio content of a digital territory to generate product mention events comprising a detected product name, a timestamp within the audio stream, and a confidence score; and incorporating signals from the product mention events into the semantic context representation.

12. The method of claim 11, wherein injecting the online price tag into a live streaming digital territory comprises: registering the online price tag as a video overlay element with a video platform overlay API; specifying a display schedule as a list of time intervals derived from the timestamp-indexed binding annotations; and rendering the online price tag as a transparent overlay above the video content at the specified time intervals and at spatial positions corresponding to the spatial regions defined in the timestamp-indexed binding annotations.

13. The method of claim 9, wherein the one or more digital territories comprise an augmented reality wearable device digital territory, and injecting the online price tag comprises: receiving a spatial context descriptor from the AR wearable device comprising device position, device orientation, and field-of-view parameters; detecting a physical object in the camera feed of the AR wearable device corresponding to a product in the product database; computing spatial anchor coordinates by transforming a bounding box of the detected physical object from camera image space into three-dimensional world space; and rendering the online price tag as an AR overlay element at the spatial anchor coordinates, attached to the detected physical object in the wearer's field of view.

14. The method of claim 9, wherein the optimization score is computed as a weighted sum of an exhibitor revenue component, a seller transaction volume component, and a buyer utility component, and selecting the optimized tuple further comprises: dynamically adjusting weight coefficients W1, W2, W3 applied to the exhibitor revenue component, the seller transaction volume component, and the buyer utility component, respectively, based on a platform saturation index, an exhibitor performance score, and a market demand index; and filtering candidate product-seller-price tuples by excluding candidates having a context-product relevance score below a configured threshold, the relevance score computed as a cosine similarity between the semantic context representation and a product embedding vector.

15. The method of claim 9, further comprising: computing an AI processing cost for the analysis performed on the target digital territory as a sum of per-unit costs for text, image, video, and audio analysis operations, wherein per-unit costs increase with computational intensity of the analysis modality; and deducting the AI processing cost from a gross exhibition fee to compute a net exhibition fee payable to the exhibitor.

16. The method of claim 9, further comprising: verifying valid exposures of the online price tag by collecting, through a telemetry script embedded within the online price tag, viewport visibility data, dwell time measurements, and user interaction signals; crediting an impression-based exhibition fee component for each exposure event in which the online price tag was rendered within a user's viewport for at least a minimum dwell time and during which at least one user interaction signal was received; and crediting a performance-based exhibition fee component upon completion of a transaction through the online price tag.

17. The method of claim 9, further comprising: collecting transaction outcome signals comprising purchase completion events, buyer satisfaction ratings, product return events, and click-through events attributed to the injected online price tags; computing reward signals from the collected outcome signals; updating context-product matching weights of the optimization engine through a policy gradient method based on the reward signals; and updating modality-specific fusion weights of the context analysis engine to increase contributions of modalities that provided high-predictive-utility context signals for the observed transaction outcomes.

18. The method of claim 9, wherein the one or more digital territories comprise a web-based digital territory or content management system territory, and injecting the online price tag comprises: parsing a Document Object Model (DOM) tree of the target digital territory; identifying semantic anchor points within the DOM tree corresponding to content elements identified by the context analysis as depicting or referencing the product selected by the optimization engine; generating a sandboxed online price tag widget code implemented as an isolated execution context; and inserting the online price tag widget code at the identified semantic anchor points in the DOM tree.

19. The system of claim 1, wherein the system is further configured to: accept an exhibitor policy certificate comprising a digitally signed data structure specifying at least: a minimum commission rate threshold, content category filters, authorized territory type permissions, and a maximum AI operational cost budget per deployment period; and enforce the exhibitor policy certificate by suppressing deployment of online price tags in territories or for product categories not authorized by the exhibitor policy certificate, and by selecting lower-cost analysis configurations when the computed AI operational cost would cause the net exhibition fee to fall below the minimum commission rate threshold.

20. The system of claim 1, wherein the issue unit is further configured to verify a valid impression by determining that: the online price tag widget has been rendered within a viewport of an end user's display device; the online price tag widget has been continuously visible within the viewport for at least a minimum dwell time threshold; and at least one user interaction signal selected from the group consisting of: a scroll event, a mouse movement event, a touch event, and a gaze fixation signal, was received from the end user's device during the dwell period.
